(19) United States
(12) Patent Application Publication
(10) Pub. No.: US 2025/0240379 A1
(43) Pub. Date: Jul. 24, 2025

(54) IMAGE PROCESSING DEVICE, INFORMATION CODE SEARCH METHOD, AND STORAGE MEDIUM

(71) Applicant: GLORY LTD., Himeji-shi (JP)

(72) Inventors: Tomomi KURISU, Himeji-shi (JP); Hidetsugu HASEBE, Himeji-shi (JP)

(73) Assignee: GLORY LTD., Himeji-shi (JP)

(21) Appl. No.: 19/180,171

(22) Filed: Apr. 16, 2025

Related U.S. Application Data
(63) Continuation of application No. PCT/JP2023/037873, filed on Oct. 19, 2023.

(30) Foreign Application Priority Data
Oct. 21, 2022 (JP) 2022-169194

(51) Int. Cl. H04N 1/407; G06T 3/40; G06V 10/75; H04N 1/40

(52) U.S. Cl. CPC H04N 1/407; G06T 3/40; G06V 10/751; H04N 1/40012

(57) ABSTRACT

An image processing device according to the present disclosure includes arithmetic circuitry. The arithmetic circuitry reduces image data to obtain reduced image data. The arithmetic circuitry recognizes at least one first intermediate tonal region with a predetermined intermediate tonal pixel value from the reduced image data. The arithmetic circuitry searches for an information code in a region of the image data corresponding to the at least one first intermediate tonal region. The arithmetic circuitry analyzes the information code.

### CROSS-REFERENCE TO RELATED APPLICATIONS

The present application is a Continuation Application of PCT Application No. PCT/JP2023/037873 filed on Oct. 19, 2023, which claims priority to Japanese Patent Application No. 2022-169194 filed on Oct. 21, 2022, under the Paris Convention and provisions of national law in a designated State. The entire contents of the application are hereby incorporated by reference.

### TECHNICAL FIELD

The present disclosure relates to a technique of reading information codes including two-dimensional codes.

### SUMMARY

A first aspect of the present disclosure is directed to an image processing device including arithmetic circuitry, the arithmetic circuitry configured to: reduce image data to obtain reduced image data; recognize at least one first intermediate tonal region with a predetermined intermediate tonal pixel value from the reduced image data; search for an information code in a region of the image data corresponding to the at least one first intermediate tonal region; and analyze the information code.

A second aspect of the present disclosure is directed to an information code search method in an information code search system, the information code search method including: reducing image data to obtain reduced image data; recognizing at least one first intermediate tonal region with a predetermined intermediate tonal pixel value from the reduced image data; searching for an information code in a region of the image data corresponding to the at least one first intermediate tonal region; and analyzing the information code.

A third aspect of the present disclosure is directed to a storage medium that stores an information code search program, the information code search program causing an image processing device to: reduce image data to obtain reduced image data;

recognize at least one first intermediate tonal region with a predetermined intermediate tonal pixel value from the reduced image data; search for an information code in a region of the image data corresponding to the at least one first intermediate tonal region; and analyze the information code.

### BRIEF DESCRIPTION OF DRAWINGS

FIG. 1 is a block diagram illustrating the configuration of an image processing device according to Embodiment 1.

FIG. 2 is a flowchart illustrating an example of the operation of the image processing device according to Embodiment 1.

FIG. 3 is a diagram showing an example of image data of a document on which a QR code is printed.

FIG. 4 is a diagram showing an example of reduced image data obtained by reduction of image data by an image data reducer in the image processing device according to the present disclosure.

FIG. 5A is a diagram showing an example of an 8×8 pixel region as a part of image data.

FIG. 5B is a diagram of 2×2 pixels as a part of the reduced image data obtained by reducing the 8×8 pixel region shown in FIG. 5A by a factor of 1/16.

FIG. 6 is a diagram showing an example of reduced image data of which first intermediate tonal regions have been recognized by an intermediate tonal region recognizer in the image processing device according to the present disclosure.

FIG. 7 is a diagram showing the example of reduced image data of which the first intermediate tonal regions have been recognized and an example of the image data showing the regions corresponding to the first intermediate tonal regions.

FIG. 8A is a diagram showing an example of image data with a QR code surrounded by white.

FIG. 8B is a diagram of reduced image data obtained by reducing the image data shown in FIG. 8A.

FIG. 8C is a chart showing the quantified amount of change in pixel value of pixels from one end to the other end of a horizontal line, the horizontal line extracted from the reduced image data shown in FIG. 8B.

FIG. 9 is a chart showing the quantified amount of change in pixel value of pixels from one end to the other end of a horizontal line, the horizontal line extracted from an example of reduced image data with white, gray, and black pixels.

FIG. 10 is a chart showing the quantified amount of change in pixel value of pixels from one end to the other end of a horizontal line, the horizontal line extracted from another example of reduced image data with white, gray, and black pixels.

FIG. 11 is a block diagram illustrating the configuration of the image processing device according to the present disclosure as a computer incorporating an image data reducer, an intermediate tonal region recognizer, and an information code searcher/analyzer.

FIG. 12 is a block diagram illustrating the configuration of an image processing device according to Embodiment 2.

FIG. 13 is a flowchart illustrating an example of the operation of the image processing device according to Embodiment 2.

FIG. 14A is a diagram showing an example of a region that does not correspond to a region with a QR code of the image data among first intermediate tonal regions of reduced image data.

FIG. 14B is a diagram showing an example of a region that does not correspond to a region with a QR code of the image data among first intermediate tonal regions of reduced image data.

FIG. 15 is a block diagram illustrating the configuration of an image processing device according to Embodiment 3.

FIG. 16 is a flowchart illustrating an example of the operation of the image processing device according to Embodiment 3.

FIG. 17 is a block diagram illustrating the configuration of an image processing device according to Embodiment 4.

FIG. 18 is a flowchart illustrating an example of the operation of the image processing device according to Embodiment 4.

FIG. 19 is a cross-sectional view showing an example of a slip handling device incorporating the image processing device according to the present disclosure.

### DESCRIPTION OF EMBODIMENTS

The present disclosure aims to provide an image processing device, an image processing system, an information code search method, and a storage medium, each allowing a high-speed search and analysis of an information code in image data acquired from a document with an information code whose position and size are not known in advance.

In order to achieve the aim, a first aspect of the present disclosure is directed to (1) an image processing device including arithmetic circuitry, the arithmetic circuitry configured to: reduce image data to obtain reduced image data; recognize at least one first intermediate tonal region with a predetermined intermediate tonal pixel value from the reduced image data; search for an information code in a region of the image data corresponding to the at least one first intermediate tonal region; and analyze the information code.

(2) In the image processing device according to (1) above, the arithmetic circuitry may be configured to calculate an average of pixel values for each of a plurality of regions of the image data, and generates image data with the calculated averages taken as pixel values as the reduced image data.

(3) In the image processing device according to (1) or (2) above, the arithmetic circuitry may be configured to recognize, as the at least one first intermediate tonal region, at least one region with a pixel value falling within a first pixel value range in the reduced image data.

(4) In the image processing device according to any one of (1) to (3) above, the arithmetic circuitry may be configured to convert the reduced image data to three pixel values of black, white, and gray, and recognizes at least one region converted to a gray pixel value as the at least one first intermediate tonal region.

(5) In the image processing device according to (3) above, in a case where the information code is not found in any region of the image data corresponding to the at least one first intermediate tonal region, the arithmetic circuitry may be configured to: recognize at least one region with a pixel value falling within a second pixel value range different from the first pixel value range as at least one second intermediate tonal region; and search for the information code in a region of the image data corresponding to the at least one second intermediate tonal region.

(6) In the image processing device according to any one of (1) to (5) above, the arithmetic circuitry may be configured to: expand the at least one first intermediate tonal region; and search for the information code in a region of the image data corresponding to the at least one region expanded.

(7) A second aspect of the present disclosure is directed to an image processing system including: a first processing device including first arithmetic circuitry configured to reduce image data to obtain reduced image data and recognize at least one first intermediate tonal region with a predetermined intermediate tonal pixel value from the reduced image data; and a second processing device including second arithmetic circuitry configured to search for an information code in a region of the image data corresponding to the at least one first intermediate tonal region and analyze the information code.

(8) A third aspect of the present disclosure is directed to an information code search method in an information code search system, the information code search method including: reducing image data to obtain reduced image data; recognizing at least one first intermediate tonal region with a predetermined intermediate tonal pixel value from the reduced image data; searching for an information code in a region of the image data corresponding to the at least one first intermediate tonal region; and analyzing the information code.

(9) In the information code search method according to (8) above, the reducing may include calculating an average of pixel values for each of a plurality of regions of the image data, and generating image data with the calculated averages taken as pixel values as the reduced image data.

(10) In the information code search method according to (8) or (9) above, the recognizing may include recognizing, as the at least one first intermediate tonal region, at least one region with a pixel value falling within a first pixel value range in the reduced image data.

(11) In the information code search method according to any one of (8) to (10) above, the recognizing may include converting the reduced image data to three pixel values of black, white, and gray, and recognizing at least one region converted to a gray pixel value as the at least one first intermediate tonal region.

(12) In the information code search method according to (10) above, the information code search method may further include, in a case where the information code is not found in any region of the image data corresponding to the at least one first intermediate tonal region in the searching, recognizing at least one region with a pixel value falling within a second pixel value range different from the first pixel value range as at least one second intermediate tonal region, and searching for the information code in a region of the image data corresponding to the at least one second intermediate tonal region.

(13) In the information code search method according to any one of (8) to (12) above, the information code search method may further include expanding the at least one first intermediate tonal region, and the searching may include searching for the information code in a region of the image data corresponding to the at least one region expanded in the expanding.

(14) A fourth aspect of the present disclosure is directed to a storage medium that stores an information code search program, the information code search program causing an image processing device to: reduce image data to obtain reduced image data; recognizing at least one first intermediate tonal region with a predetermined intermediate tonal pixel value from the reduced image data; searching for an information code in a region of the image data corresponding to the at least one first intermediate tonal region; and analyzing the information code.

(15) In the storage medium according to (14) above, the reducing in the information code search program may include calculating an average of pixel values for each of a plurality of regions of the image data, and generating image data with the calculated averages taken as pixel values as the reduced image data.

(16) In the storage medium according to (14) or (15) above, the recognizing in the information code search program may include recognizing, as the at least one first intermediate tonal region, at least one region with a pixel value falling within a first pixel value range in the reduced image data.

(17) In the storage medium according to any of (14) to (16) above, the recognizing in the information code search program may include converting the reduced image data to three pixel values of black, white, and gray, and recognizing at least one region converted to a gray pixel value as the at least one first intermediate tonal region.

(18) In the storage medium according to (16) above, in a case where the information code is not found in any region of the image data corresponding to the at least one first intermediate tonal region in the searching in the information code search program, the information code search program may cause the image processing device to: recognize at least one region with a pixel value falling within a second pixel value range different from the first pixel value range as at least one second intermediate tonal region, and search for the information code in a region of the image data corresponding to the at least one second intermediate tonal region.

(19) In the storage medium according to any of (14) to (18) above, the information code search program may cause the image processing device to further expand the at least one first intermediate tonal region, and the searching in the information code search program may include searching for the information code in a region of the image data corresponding to the at least one region expanded in the expanding.

The present disclosure can provide an image processing device, an image processing system, an information code search method, and a storage medium, each allowing a high-speed search and analysis of an information code in image data acquired from a document with an information code whose position and size are not known in advance.

Hereinbelow, embodiments of an image processing device, an image processing system, an information code search method, and a storage medium according to the present disclosure are described in detail with reference to the drawings.

The same components or components having similar functions in the following description are commonly assigned with the same reference sign throughout the drawings as appropriate, and description thereof is omitted as appropriate. Drawings showing a structure appropriately include the XYZ coordinate system where the XYZ axes are perpendicular to one another.

### Embodiment 1

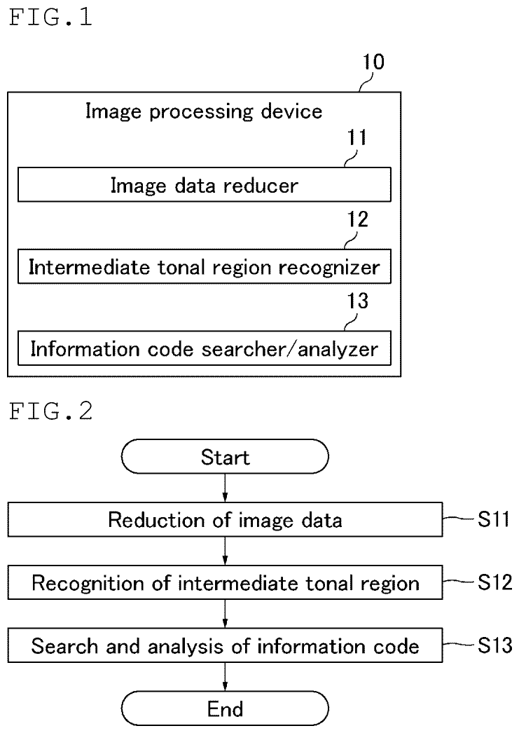

FIG. 1 is a block diagram illustrating the configuration of an image processing device according to Embodiment 1.

As shown in FIG. 1, an image processing device 10 includes an image data reducer 11, an intermediate tonal region recognizer 12, and an information code searcher/analyzer 13. The image data reducer 11, the intermediate tonal region recognizer 12, and the information code searcher/analyzer 13 may be processed by an arithmetic processor including arithmetic circuitry such as a CPU.

The image data reducer 11, the intermediate tonal region recognizer 12, and the information code searcher/analyzer 13 function when a program described below is executed.

With reference to FIG. 2, the operation of the image processing device according to Embodiment 1 is described.

FIG. 2 is a flowchart illustrating an example of the operation of the image processing device according to Embodiment 1.

As shown in FIG. 2, in the image processing device 10, first, the image data reducer 11 reduces image data to obtain reduced image data (step S11).

Next, the intermediate tonal region recognizer 12 recognizes any first intermediate tonal region with a predetermined intermediate tonal pixel value from the reduced image data (step S12).

Subsequently, the information code searcher/analyzer 13 searches for and analyzes an information code in any region of the image data corresponding to at least one first intermediate tonal region (step S13), so that the operation of the image processing device 10 ends.

With the image processing device 10, a high-speed search and analysis of an information code on a document can be executed.

The information code to be searched by the image processing device according to the present disclosure may be any code containing information encoded by combining given types of cells within a predetermined range, such as a one-dimensional code or a two-dimensional code. Examples of the information code include one-dimensional barcodes and QR codes.

While cells constituting a one-dimensional barcode or a QR code include those of two colors, black and white, an information code searchable by the image processing device according to the present disclosure may include color cells.

In the image processing device 10, the image data reducer 11 and the intermediate tonal region recognizer 12 may be integrated to integrally execute step S11 and step S12 above.

In the image processing device 10, the information code searcher/analyzer 13 may search for and analyze an information code only in regions of the image data corresponding to at least one first intermediate tonal region.

This can increase the search and analysis speed when multiple documents are to be handled.

The image processing device according to the present disclosure may not include the integrated information code searcher/analyzer but may include an information code searcher and an information code analyzer separately.

In the image processing device 10, the information code searcher/analyzer 13 may preferentially search for an information code in regions of the image data corresponding to at least one first intermediate tonal region, and may, if not being able to find the information code, search for and analyze the information code across the entire image data. Here, a search for the information code may be executed in regions with a pixel value higher than the pixel value (upper limit value) of the first intermediate tonal regions, and if the information code still cannot be found, then a search for the information code may be executed in regions with a pixel value lower than the pixel value (lower limit value) of the first intermediate tonal regions.

Alternatively, a search for the information code may be executed in regions with a pixel value lower than the pixel value (lower limit value) of the first intermediate tonal regions, and if the information code still cannot be found, then a search for the information code may be executed in regions with a pixel value higher than the pixel value (upper limit value) of the first intermediate tonal regions.

The search for the information code in such a manner allows the information code to be more easily found even when the information code is not located in regions of the image data corresponding to at least one first intermediate tonal region.

The principle by which the image processing device 10 can search for and analyze an information code at high speed will now be described.

Information codes such as one-dimensional barcodes and two-dimensional codes are created by combining multiple types of data cells (e.g., two types of data cells, black and white) based on certain rules according to the type of information code.

The ratio of the data cell types used in one information code is also determined based on the rules above.

Thus, in image data containing an information code, averaging the pixel values of all the pixels constituting the information code results in a constant pixel value. Also, averaging the pixel values of the pixels constituting a region of the information code results in a value equal to or close to the average of the pixel values of all the pixels constituting the information code.

This means that when the average of the pixel values is calculated for each predetermined region of the image data and image data with the calculated averages taken as pixel values is generated as reduced image data, the pixel value of a region of the reduced image data corresponding to a region with the information code of the image data is a value equal to or close to the average of the pixel values of all the pixels constituting the information code.

Therefore, in the reduced image data, a pixel with a pixel value equal to or close to the average of the pixel values of all the pixels constituting the information code is highly likely to be a pixel resulting from reduction of the region with the information code. Conversely, in the reduced image data, a pixel with a pixel value far from the average of the pixel values of all the pixels constituting the information code is highly likely to be a pixel resulting from reduction of a region without the information code.

In other words, with reference to the pixel value of each pixel constituting the reduced image data, it is possible to determine whether there is a high likelihood that the pixel corresponds to a region with the information code.

Since the average of the pixel values of all the pixels constituting the information code should be an intermediate tonal pixel value, in the reduced image data, a region with a pixel value equal to or close to the intermediate tonal pixel value is recognized as a first intermediate tonal region, and a search and analysis of the information code is executed in the region of the image data corresponding to the first intermediate tonal region, so that an efficient search and analysis of the information code is achieved.

Hereinbelow, the principle by which the image processing device 10 can search for and analyze an information code at high speed will be described in more detail based on an example in which the information code is a QR code, a type of two-dimensional code.

<Image Data of Document on which QR Code is Printed>

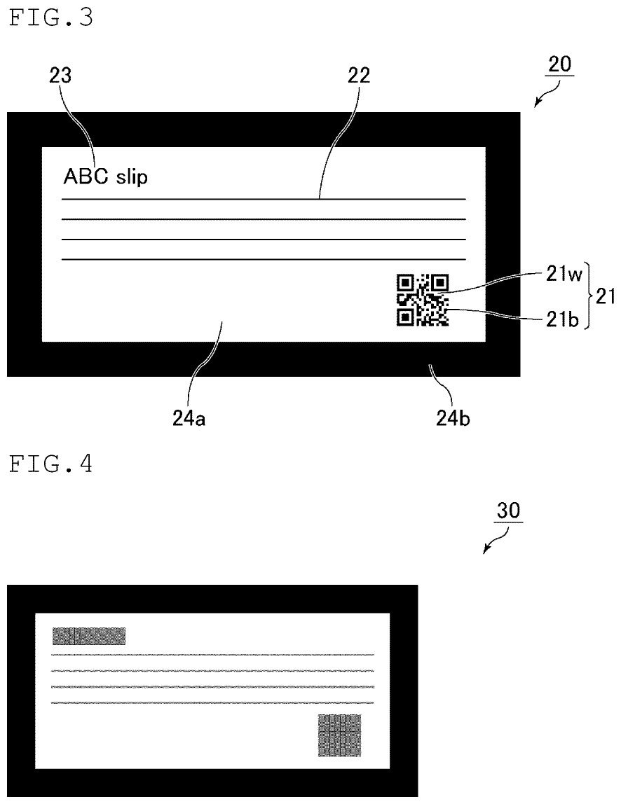

FIG. 3 is a diagram showing an example of image data of a document on which a QR code is printed.

Image data 20 shown in FIG. 3 is acquired from a document with a QR code and includes a QR code 21, ruled lines 22, text 23, a base 24a, and a background 24b.

The image data may be acquired from the document with a QR code by any method. Examples include acquiring image data using a digital camera or an image scanner.

The image processing device 10 may include an image data acquisitor which acquires image data.

The image data 20 is typically a grayscale image, but may be a black-and-white image (binary image), an RGB full-color image, or an RGB monotone image, for example.

When the image data 20 is a grayscale image, the grayscale is not limited and may consist of 256 values.

The resolution of the image data 20 is not limited.

The QR code 21 is an information code containing information encoded by combining black cells 21b and white cells 21w in combination.

A QR code is designed such that the ratio of the black cells to the white cells is 1:1.

Thus, in the image data 20 shown in FIG. 3, the ratio of the number of pixels constituting the black cells 21b to the number of pixels constituting the white cells 21w is 1:1.

### <Function of Image Data Reducer (Step S11)>

FIG. 4 is a diagram showing an example of reduced image data obtained by reduction of image data by an image data reducer in the image processing device according to the present disclosure.

In the image processing device 10, the image data reducer 11 reduces the image data 20 to obtain reduced image data 30 as shown in FIG. 4.

The image data reducer 11 may calculate the average of the pixel values for each predetermined region of the image data 20 and generate image data with the calculated averages taken as the pixel values as the reduced image data 30.

The reduction is described based on a case where the image data 20 is reduced by a factor of 1/16 to generate the reduced image data 30.

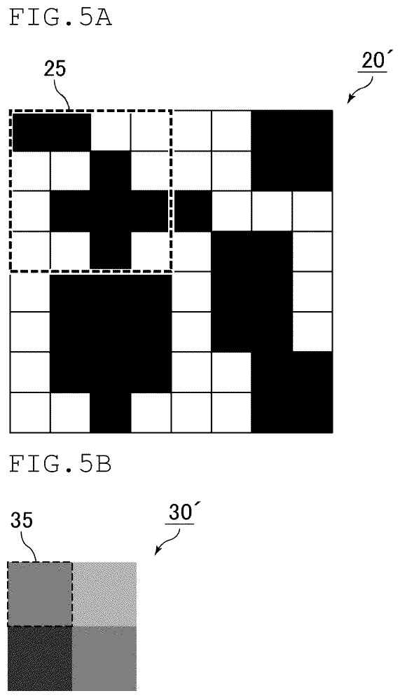

FIG. 5A is a diagram showing an example of an 8×8 pixel region as a part of image data.

FIG. 5B is a diagram of 2×2 pixels as a part of the reduced image data obtained by reducing the 8×8 pixel region shown in FIG. 5A by a factor of 1/16.

Image data 20′ shown in FIG. 5A is a part of the image data 20 and consists of an 8×8 pixel region. The image data 20′ includes a region 25 of 4×4 pixels. The region 25 corresponds to a region 35 of a 1×1 pixel (i.e., 1 pixel) of reduced image data 30′ shown in FIG. 5B as a part of the reduced image data 30.

When the image data reducer 11 reduces the image data 20′ to obtain the reduced image data 30′, the image data reducer 11 calculates the average (arithmetic mean value) of the pixel values of the 4×4 pixels in the region 25 of the image data 20′. The image data reducer 11 then generates the pixel in the region 35 with the calculated average (arithmetic mean value) taken as the pixel value.

Such a reduction is performed for all the regions of the image data 20, so that the image data 20 can be converted to the reduced image data 30.

The case described above using FIG. 5A and FIG. 5B includes reducing the image data 20 by a factor of 1/16 to generate the reduced image data 30.

In the image processing device according to the present disclosure, the factor of reduction when the image data reducer reduces the image data is not limited. For example, the factor of reduction may be 1/21 to 1/19.

A factor of reduction of less than 1/21 may make it difficult to find an information code.

A factor of reduction of more than 1/19 may make it difficult to achieve a high-speed search and analysis of an information code.

The case described above using FIG. 5A and FIG. 5B includes reducing the region 25 of 4×4 pixels in the image data 20 to 1 pixel (region 35) in the reduced image data 30.

In the image processing device according to the present disclosure, the shape and size of a region when the image data reducer reduces the image data are not limited. The case described above using FIG. 5A and FIG. 5B includes reducing the region 25 with an equal number of vertically and horizontally arranged pixels in the image data 20 to 1 pixel (region 35) in the reduced image data 30. In the image processing device according to the present disclosure, a region with different numbers of pixels arranged vertically and horizontally may be reduced to 1 pixel in the reduced image data.

The case described above using FIG. 5A and FIG. 5B includes calculating the arithmetic mean value of the pixel values of the pixels in the region 25 of the image data 20 to generate the pixel with the calculated arithmetic mean value taken as the pixel value as a pixel in the reduced image data 30. In the image processing device according to the present disclosure, the pixel values of the reduced image data to be generated may be any values based on the pixel values of the original image data.

### <Function of Intermediate Tonal Region Recognizer (Step S12)>

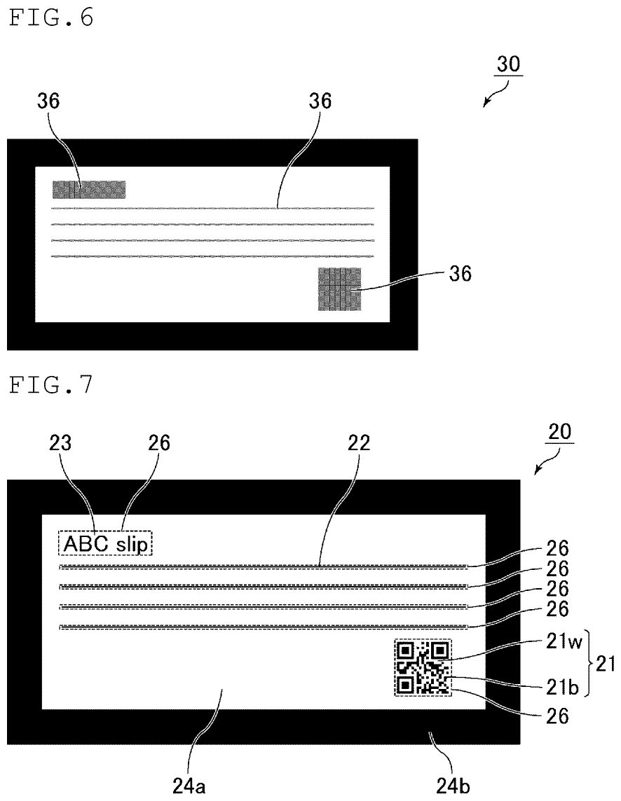

FIG. 6 is a diagram showing an example of reduced image data of which first intermediate tonal regions have been recognized by an intermediate tonal region recognizer in the image processing device according to the present disclosure.

As shown in FIG. 6, in the image processing device 10, the intermediate tonal region recognizer 12 recognizes any first intermediate tonal region 36 with a predetermined intermediate tonal pixel value from the reduced image data 30.

The “first intermediate tonal region with a predetermined intermediate tonal pixel value” herein may refer to a region determined based on whether the pixel value of the pixel is within the predetermined pixel value range or may refer to a region determined based on the amount of change in pixel value between adjacent pixels.

The “predetermined pixel value range” means any range of pixel values (tones) excluding at least the maximum and minimum tonal values of the pixels constituting the image data 20.

The following describes a case where the “first intermediate tonal region with a predetermined intermediate tonal pixel value” is a region determined based on whether the pixel value of the pixel is within the predetermined pixel value range.

In other words, the following describes a case where the intermediate tonal region recognizer 12 recognizes any region with a pixel value falling within a first pixel value range in the reduced image data 30 as a first intermediate tonal region 36.

The intermediate tonal region recognizer 12 refers to the pixel values of the pixels constituting the reduced image data 30 to determine whether the pixel values fall within the first pixel value range. Then, the intermediate tonal region recognizer 12 recognizes any pixel with a pixel value falling within the first pixel value range as constituting a first intermediate tonal region 36.

The first pixel value range may appropriately be set according to the type of information code to be searched and the color of the background of the document on which the information code is printed, for example.

For example, when the image data 20 is a grayscale image with 256 values, the first pixel value range may be values from 50 to 200 or may be values from 100 to 150.

The intermediate tonal region recognizer 12 may convert the reduced image data 30 to three pixel values of black, white, and gray, and recognize any region converted to a gray pixel value as a first intermediate tonal region 36. The conversion to three pixel values means converting a pixel with a pixel value within a predetermined range to a gray pixel with a predetermined pixel value, converting a pixel with a pixel value less than the lower limit of the predetermined range to a black pixel with the minimum pixel value, and converting a pixel with a pixel value more than the upper limit of the predetermined range to a white pixel with the maximum pixel value.

For example, when the image data 20 is a grayscale image with 256 values, a pixel with a pixel value of 50 to 200 may be converted to a pixel with a value of 100, a pixel with a pixel value of 49 or less may be converted to a pixel with a value of 0, and a pixel with a pixel value of 201 or more may be converted to a pixel with a value of 255.

In this case, a pixel value within the first pixel value range means the pixel value of gray which has a pixel value of 100.

Although an example in which each pixel is converted to a pixel with any of three pixel values based on the pixel value of the pixel, the image processing device according to the present disclosure may convert each pixel to one with any of the three pixel values based on a parameter other than the first pixel value range.

For example, each pixel may be converted to one with any of the three pixel values based on the amount of change in pixel value between consecutive pixels (described in detail later).

Also, the average of pixel values of the pixels may be calculated, and each pixel may be converted to one with any of the three pixel values based on its degree of deviation from the calculated average. The “degree of deviation from the average” may be determined based on the pixel value or on the standard deviation of the pixel value.

For example, when the pixel value of a given pixel is less than “the average-a, wherein “a” is a predetermined value “, the given pixel may be converted to a pixel with a value of 0. The pixel value of the given pixel is “the average-a” or more and “the average+a” or less, the given pixel may be converted to a pixel with a value of 100. When the pixel value of the given pixel is more than “the average+a”, the given pixel may be converted to a pixel with a value of 255.

Also, for example, when the pixel value of a given pixel is less than “the average-standard deviation×b, wherein “b” is a predetermined variable “, the given pixel may be converted to a pixel with a value of 0. When the pixel value of the given pixel is “the average−standard deviation×b” or more and “the average+standard deviation×b” or less, the given pixel may be converted to a pixel with a value of 100. When the pixel value of the given pixel is more than “the average+standard deviation×b”, the given pixel may be converted to a pixel with a value of 255.

Here, the purpose of recognizing the first intermediate tonal regions will be described based on a case where the information code is a QR code.

As described above, a QR code is designed such that the ratio of the number of black cells to the number of white cells is 1:1.

Thus, reducing image data by the method described in <Function of image data reducer (step S11)>above causes the pixel value of a region of the reduced image data corresponding to the region with a QR code of the image data to be a value equal to or close to the average (arithmetic mean value) of the pixel value of one black cell and the pixel value of one white cell.

This means that in the reduced image data, a pixel with a pixel value equal to or close to the arithmetic mean value of the pixel value of one black cell and the pixel value of one white cell is highly likely to be a pixel obtained by reducing the region with the QR code.

Conversely, in the reduced image data, a pixel with a pixel value far from the arithmetic mean value of the pixel value of one black cell and the pixel value of one white cell is highly likely to be a pixel obtained by reducing a region without the QR code. Examples of such a pixel include pixels obtained by reducing the base 24a or the background 24b of the image data 20.

In other words, with reference to the pixel value of a pixel constituting the reduced image data, whether the pixel is highly likely to be a pixel corresponding to the region with the QR code can be determined.

Thus, when the “predetermined intermediate tonal pixel value” is set to be any value within a range close to or including the arithmetic mean value of the pixel value of one black cell and the pixel value of one white cell, the likelihood of finding the QR code in a region of the image data corresponding to any of the recognized first intermediate tonal regions increases.

The purpose of recognizing the first intermediate tonal regions is to recognize any region highly likely to contain the QR code as the region to be searched by an information code searcher/analyzer, which will be described later.

### <Function of Information Code Searcher/Analyzer (Step S13)>

FIG. 7 is a diagram showing the example of reduced image data of which the first intermediate tonal regions have been recognized and an example of the image data showing the regions corresponding to the first intermediate tonal regions.

As shown in FIG. 7, in the image processing device 10, an information code searcher/analyzer 13 searches for and analyzes the QR code 21 in regions 26 of the image data 20 corresponding to the first intermediate tonal regions 36.

As described above, the QR code 21 is highly likely to be in the regions 26 of the image data 20 corresponding to the first intermediate tonal regions 36. Thus, searching in the regions 26 of the image data 20, the information code searcher/analyzer 13 can find the QR code with a high likelihood.

In addition, the range to be searched for the QR code 21 by the information code searcher/analyzer 13 is narrowed down to the regions 26 of the image data 20, so that the QR code 21 can be found at a higher speed than when the QR code 21 is searched across the entire image data 20.

Also, a region of the reduced image data 30 corresponding to the region with the QR code 21 of the image data 20 is likely to be recognized as a first intermediate tonal region 36. Thus, even when the position and size of the QR code 21 in the image data 20 cannot be known in advance, the information code searcher/analyzer 13, searching in the regions 26 of the image data 20, can find the QR code 21 with a high likelihood.

(Modified example of Embodiment 1)

Next, a modified example of the image processing device according to Embodiment 1 is described.

In the image processing device 10, the intermediate tonal region recognizer 12 recognizes any region with a pixel value within the first pixel value range as a first intermediate tonal region.

In the image processing device according to Embodiment 1, the intermediate tonal region recognizer may recognize first intermediate tonal regions based on the amount of change in pixel value between consecutive pixels in the reduced image data.

The recognition of first intermediate tonal regions is described below with reference to an example in which the image data contains a QR code surrounded by white.

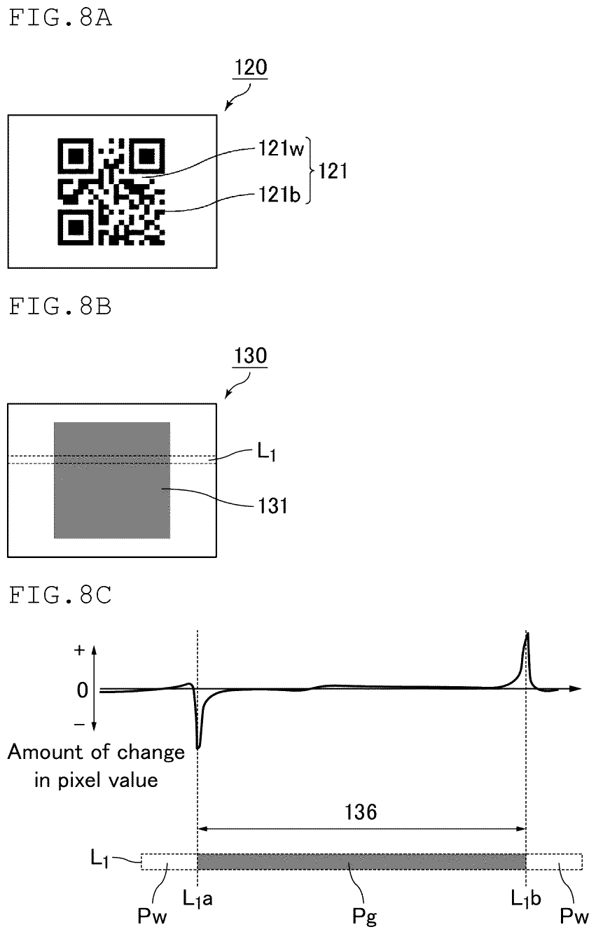

FIG. 8A is a diagram showing an example of image data with a QR code surrounded by white.

FIG. 8B is a diagram of reduced image data obtained by reducing the image data shown in FIG. 8A.

FIG. 8C is a chart showing the quantified amount of change in pixel value of pixels from one end to the other end of a horizontal line, the horizontal line extracted from the reduced image data shown in FIG. 8B.

Image data 120 shown in FIG. 8A contains a QR code 121 surrounded by white pixels. The QR code 121 is designed such that the ratio of black cells 121b to white cells 121w is 1:1.

When the image data 120 is reduced to obtain reduced image data 130 as shown in FIG. 8B, the region with the QR code 121 of the image data 120 is converted to a region consisting of pixels with intermediate tonal pixel values (hereinbelow, “gray region 131”) in the reduced image data 130. In other words, the pixel values of the pixels constituting the gray region 131 are equal to or close to the average (arithmetic mean value) of the pixel value of one black cell 121b and the pixel value of one white cell 121w.

Also, the pixels surrounding the gray region 131 in the reduced image data 130 are converted to white pixels.

For convenience, a case is described where no black pixel is present in the reduced image data 130 (a case where a black pixel is present will be described later).

As shown in FIG. 8B, when one horizontal line L₁ of pixels constituting the reduced image data 130 is extracted and the amount of change in pixel value of these pixels from one end to the other end is quantified, the amount of change will appear as shown in the chart in FIG. 8C.

In FIG. 8C, the horizontal axis corresponds to the pixels from one end to the other end (i.e., one unit along the horizontal axis corresponds to one pixel), and the vertical axis indicates the amount of change in pixel value between adjacent pixels, from left to right.

As shown in FIG. 8C, the amount of change in pixel value of pixels of the line L₁ can be described as follows. For adjacent pixels where both are white pixels Pw, the amount of change in pixel value from the left pixel to the right pixel is a value close to 0, and the absolute value thereof is close to 0.

For adjacent pixels where the left pixel is a white pixel Pw and the right pixel is a gray pixel Pg, the amount of change in pixel value from the left pixel to the right pixel is a negative value, and the absolute value thereof is large.

For adjacent pixels where both are gray pixels Pg, the amount of change in pixel value from the left pixel to the right pixel is close to 0, and the absolute value thereof is close to 0.

For adjacent pixels where the left pixel is a gray pixel Pg and the right pixel Pw is a white pixel, the amount of change in pixel value from the left pixel to the right pixel is a positive value, and the absolute value thereof is large.

Thus, in the line L₁, the peak where the amount of change in pixel value changes significantly from a value close to 0 toward a negative value (i.e., the peak where the amount of change is a negative value and its absolute value is large) may be defined as a first boundary Lia, the peak where the amount of change in pixel value changes significantly from a value close to 0 toward a positive value (i.e., the peak where the amount of change is a positive value and its absolute value is large) may be defined as a second boundary Lib, and the region between the first boundary Lia and the second boundary Lib may be recognized as a first intermediate tonal region 136.

The standard magnitude of the absolute value of “the peak where the amount of change is a negative value and its absolute value is large”, and the standard magnitude of the absolute value of “the peak where the amount of change is a positive value and its absolute value is large” may be preset.

The case where no black pixel is present in the reduced image data has been described above.

However, in the cases where black pixels are present in a wide range in the image data, its reduced image data may include a black pixel to the right of a white pixel, may include a black pixel to the right of a gray pixel, may include a gray pixel to the right of a black pixel, or may include a white pixel to the right of a black pixel.

The following describes these cases.

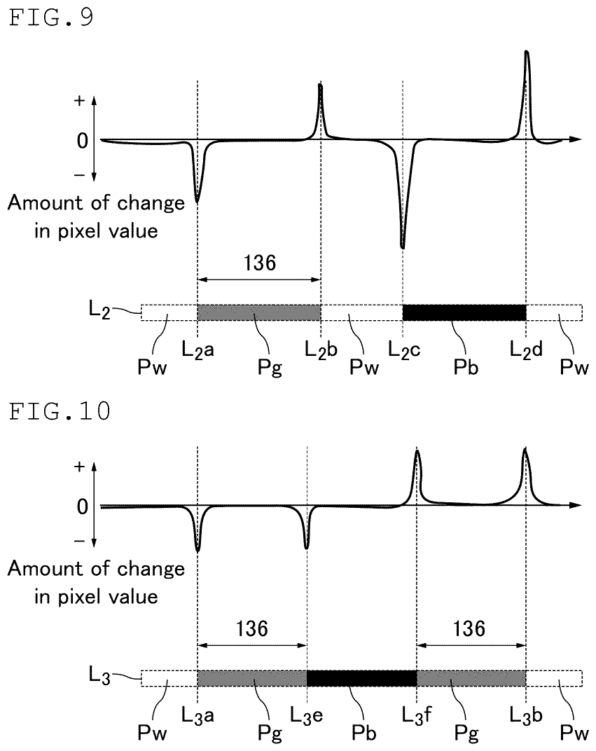

FIG. 9 is a chart showing the quantified amount of change in pixel value of pixels from one end to the other end of a horizontal line, the horizontal line extracted from an example of reduced image data with white, gray, and black pixels.

In a line L: shown in FIG. 9, from left to right, there are a white pixel Pw region, a gray pixel Pg region, a white pixel Pw region, a black pixel Pb region, and a white pixel Pw region in this order.

In FIG. 9, in the region including the white pixel Pw region, the gray pixel Pg region, and the white pixel Pw region in this order, as in FIG. 8C, a first boundary Lea and a second boundary Leb can be determined, so that the region from the first boundary La to the second boundary Leb can be recognized as a first intermediate tonal region 136.

In FIG. 9, for the adjacent pixels where the white pixel Pw is to the right and the black pixel Pb is to the left, the amount of change in pixel value from the left pixel to the right pixel is a negative value, and its absolute value is large.

Thus, determining only whether the amount of change in pixel value is positive or negative does not allow determination of whether the change is from the white pixel Pw to the black pixel Pb or from the white pixel Pw to the gray pixel Pg.

Still, the absolute value of the amount of change from a white pixel Pw to a black pixel Pb is larger than the absolute value of the amount of change from a white pixel Pw to a gray pixel Pg.

Thus, when the amount of change in pixel value is a negative value and its absolute value is more than the predetermined value, the part in question is determined as a change from a white pixel Pw to a black pixel Pb and is defined as a third boundary Loc.

Also, the absolute value of the amount of change from a black pixel Pb to a white pixel Pw is larger than the absolute value of the amount of change from a gray pixel Pg to a white pixel Pw.

Thus, when the amount of change in pixel value is a positive value and its absolute value is more than the predetermined value, the part in question is determined as a change from a black pixel Pb to a white pixel Pw and is defined as a fourth boundary Led.

Then, the region from the third boundary L₂c to the fourth boundary Led is determined as a region with a black pixel Pb, so that only a region with a gray pixel Pg can be recognized as a first intermediate tonal region 136.

FIG. 10 is a chart showing the quantified amount of change in pixel value of pixels from one end to the other end of a horizontal line, the horizontal line extracted from another example of reduced image data with white, gray, and black pixels.

In a line L₃ shown in FIG. 10, from left to right, there are a white pixel Pw region, a gray pixel Pg region, a black pixel Pb region, a gray pixel Pg region, and a white pixel Pw region in this order.

As shown in FIG. 10, in the line L₃, the amount of change from the white pixel Pw to the gray pixel Pg is a negative value, and the amount of change from the gray pixel Pg to the black pixel Pb is a negative value.

Also, the absolute value of the amount of change from the white pixel Pw to the gray pixel Pg is close to the absolute value of the amount of change from the gray pixel Pg to the black pixel Pb.

Thus, determining only whether the amount of change in pixel value is positive or negative and determining the magnitude of the absolute value of the amount of change do not allow the determination of whether the change is from the white pixel Pw to the gray pixel Pg or from the gray pixel Pg to the black pixel Pb.

Still, in the line L₃ including the white pixels Pw at its ends, the change from the gray pixel Pg to the black pixel Pb should be preceded by the change from the white pixel Pw to the gray pixel Pg. In other words, there is a first boundary L₃a where the amount of change in pixel value is a negative value and its absolute value is within the predetermined range.

Thus, the part where the amount of change in pixel value is a negative value and its absolute value is within the predetermined range after the first boundary L₃a can be determined as the change from the gray pixel Pg to the black pixel Pb. Such a part is defined as a fifth boundary L₃e.

As shown in FIG. 10, in the line L₃, the amount of change from the black pixel Pb to the gray pixel Pg is a positive value, and the amount of change from the gray pixel Pg to the white pixel Pw is a positive value.

Also, the absolute value of the amount of change from the black pixel Pb to the gray pixel Pg is close to the absolute value of the amount of change from the gray pixel Pg to the white pixel Pw.

Thus, determining only whether the amount of change in pixel value is positive or negative and determining the magnitude of the absolute value of the amount of change do not allow the determination of whether the change is from the black pixel Pb to the gray pixel Pg or from the gray pixel Pg to the white pixel Pw.

Still, as shown in FIG. 10, in the line L₃, the change from the black pixel Pb to the gray pixel Pg should be preceded by the fifth boundary L₃e where the change is from the gray pixel Pg to the black pixel Pb.

Thus, the part where the amount of change in pixel value is a positive value and its absolute value is within the predetermined range after the fifth boundary Lse can be determined as the change from the black pixel Pb to the gray pixel Pg. Such a part is defined as a sixth boundary L₃f.

As shown in FIG. 10, in the line L₃, the amount of change from the gray pixel Pg to the white pixel Pw is a positive value.

Also, the absolute value of the amount of change from the gray pixel Pg to the white pixel Pw is close to the absolute value of the amount of change from the black pixel Pb to the gray pixel Pg.

Thus, determining only whether the amount of change in pixel value is positive or negative and determining the magnitude of the absolute value of the amount of change do not allow the determination of whether the change is from the gray pixel Pg to the white pixel Pw or from the black pixel Pb to the gray pixel Pg.

Still, as shown in FIG. 10, in the line L₃, the change from the gray pixel Pg to the white pixel Pw should be preceded by the sixth boundary L₃f where the change is from the black pixel Pb to the gray pixel Pg.

Thus, the part where the amount of change in pixel value is a positive value and its absolute value is within the predetermined range after the sixth boundary L₃f can be determined as the change from the gray pixel Pg to the white pixel Pw. Such a part is defined as a second boundary L₃b.

In the line L₃ including the first boundary L₃a, the fifth boundary L₃e, the sixth boundary L₃f, and the second boundary L₃b, the region between the first boundary L₃a and the second boundary L₃b, excluding the region between the fifth boundary L₃e and the sixth boundary L₃f, may be recognized as a first intermediate tonal region 136.

As described above, in the image processing device according to the present disclosure, the intermediate tonal region recognizer may refer to a boundary preceding a part where the absolute value of the amount of change in pixel value is large and may determine what boundary the part is to recognize a first intermediate tonal region.

The intermediate tonal region recognizer may also convert a region defined by boundaries to three pixel values of black, white, and gray to recognize a region converted to a gray pixel value as a first intermediate tonal region.

The image processing device according to the present disclosure may be a computer incorporating an image data reducer, an intermediate tonal region recognizer, and an information code searcher/analyzer. Such a case is described below based on the drawings.

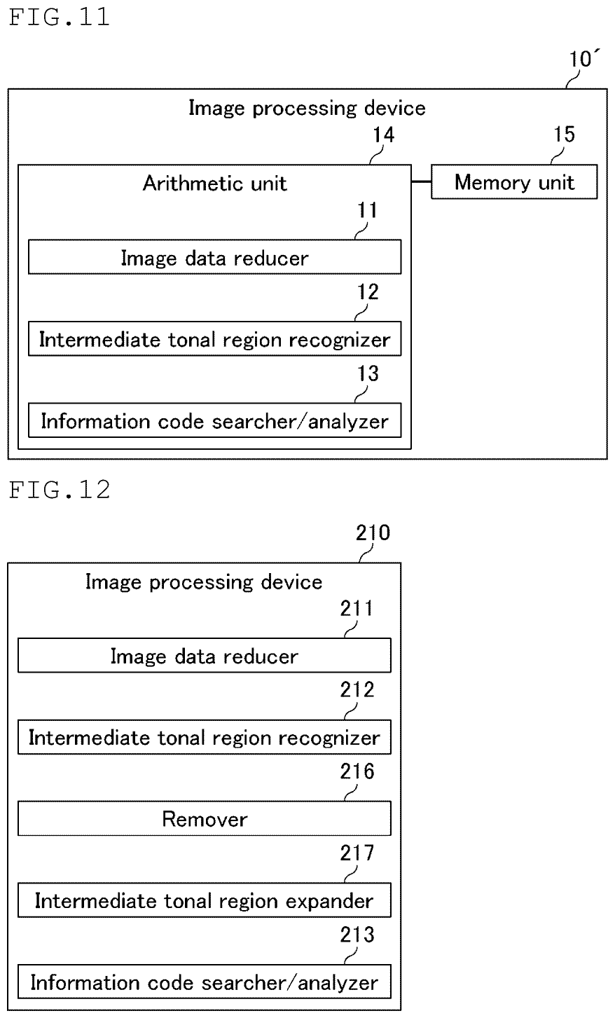

FIG. 11 is a block diagram illustrating the configuration of the image processing device according to the present disclosure as a computer incorporating an image data reducer, an intermediate tonal region recognizer, and an information code searcher/analyzer.

An image processing device 10′ shown in FIG. 11 includes an arithmetic unit 14 and a memory unit 15.

The arithmetic unit 14 includes the image data reducer 11, the intermediate tonal region recognizer 12, and the information code searcher/analyzer 13, and process these components.

In other words, the arithmetic unit 14 includes arithmetic circuitry such as a CPU, for example, and functions as the image data reducer 11, the intermediate tonal region recognizer 12, and the information code searcher/analyzer 13.

The memory unit 15 is a memory, for example, and stores programs or executable instructions to control the image data reducer 11, the intermediate tonal region recognizer 12, and the information code searcher/analyzer 13, the pixel values of image data, and other information.

In the image processing device 10′, the arithmetic unit 14 executes programs stored in the memory unit 15 to process the image data reducer 11, the intermediate tonal region recognizer 12, and the information code searcher/analyzer 13.

The arithmetic unit disclosed herein may be implemented using circuitry or processing circuitry which may include general purpose processors, special purpose processors, integrated circuits, ASICs (“Application Specific Integrated Circuits”), conventional circuitry and/or combinations thereof which are configured or programmed to perform the disclosed functionality.

Processors are processing circuitry or circuitry as they include transistors and other circuitry therein. The processor may be a programmed processor which executes a program stored in a memory. In the disclosure, the processing circuitry, units, or means are hardware that carry out or are programmed to perform the recited functionality. The hardware may be any hardware disclosed herein or otherwise known which is programmed or configured to carry out the recited functionality.

Further, the claimed advancements are not limited by the form of the memory on which the instructions of the above-described process are stored. For example, the instructions may be stored on CDs, DVDs, in FLASH memory, RAM, ROM, PROM, EPROM, EEPROM, hard disk or any other non-transitory computer readable medium of an information processing device with which the processing circuitry communicates, such as a server or computer. The processes may also be stored in network-based storage, cloud-based storage or other mobile accessible storage and executable by processing circuitry.

### (Information Code Search Program)

In the image processing device 10 (the arithmetic unit 14 of the image processing device 10′), a program to reduce image data to obtain reduced image data (the process in step S11), recognize any first intermediate tonal region with a predetermined intermediate tonal pixel value from the reduced image data (the process in step S12), and search for and analyzing an information code in any region of the image data corresponding to at least one first intermediate tonal region (the process in step S13) is the information code search program according to the present disclosure.

The information code search program may be preinstalled in the image processing device 10 or may be provided to a user as a program stored in a computer-readable storage medium or via a network.

### Embodiment 2

Next, an image processing device according to Embodiment 2 of the present disclosure is described.

An image processing device according to Embodiment 2 is different from the image processing device according to Embodiment 1 in that the device includes a remover which removes noise and an intermediate tonal region expander in addition to the image data reducer, the intermediate tonal region recognizer, and the information code searcher/analyzer.

FIG. 12 is a block diagram illustrating the configuration of the image processing device according to Embodiment 2.

An image processing device 210 shown in FIG. 12 includes an image data reducer 211, an intermediate tonal region recognizer 212, a remover 216, an intermediate tonal region expander 217, and an information code searcher/analyzer 213. The image data reducer 211, the intermediate tonal region recognizer 212, the remover 216, the intermediate tonal region expander 217, and the information code searcher/analyzer 213 may be processed by an arithmetic processor including arithmetic circuitry such as a CPU.

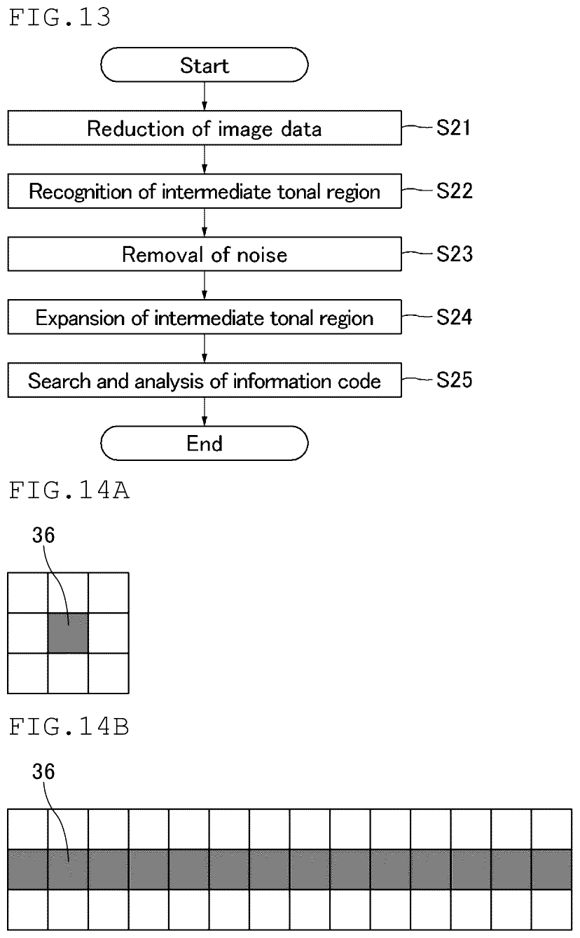

The operation of the image processing device according to Embodiment 2 is described based on FIG. 13.

FIG. 13 is a flowchart illustrating an example of the operation of the image processing device according to Embodiment 2.

As shown in FIG. 13, in the image processing device 210 according to Embodiment 2, the image data reducer 211 first reduces image data to obtain reduced image data (step S21).

Next, the intermediate tonal region recognizer 212 recognizes any first intermediate tonal region with a predetermined intermediate tonal pixel value from the reduced image data (step S22).

The remover 216, which removes noise, removes any region to be noise from the reduced image data (step S23).

Then, the intermediate tonal region expander 217 expands any first intermediate tonal region of the reduced image data from which any region to be noise has been removed (step S24).

Next, the information code searcher/analyzer 213 searches for and analyzes an information code in any region of the image data corresponding to the region(s) expanded by the intermediate tonal region expander 217 (step S25), so that the operation of the image processing device ends.

The following more specifically describes the principle by which the image processing device 210 can search for and analyze an information code at high speed, based on a case where the information code is a QR code, a type of two-dimensional code.

The image data, step S21, and step S22 are respectively the same as the image data, step S11, and step S12 in the description of the image processing device according to Embodiment 1.

### <Function of Remover (Step S23)>

The first intermediate tonal regions 36 of the reduced image data 30 possibly include a region not corresponding to the region with the QR code 21 in the image data 20.

Such a region not corresponding to the region with the QR code 21 in the image data 20 is better to be excluded from the regions to be searched by the information code searcher/analyzer 213 to efficiently find the QR code 21.

For example, any first intermediate tonal region 36 having the following characteristics may be removed by the remover 216 as noise which does not correspond to the region with the QR code 21 in the image data 20.

FIG. 14A and FIG. 14B are each a diagram showing an example of a region that does not correspond to a region with a QR code of the image data among first intermediate tonal regions of reduced image data.

As shown in FIG. 14A, in the case of a first intermediate tonal region 36 that consists only of 1 pixel and is surrounded by pixels with a pixel value more than the upper limit of the predetermined intermediate tonal values (e.g., in the case where 1 pixel as a first intermediate tonal region 36 is surrounded by 8 pixels which are all white pixels), the 1 pixel recognized as constituting a first intermediate tonal region 36 is highly possibly a region (noise) not corresponding to the region with the QR code 21 in the image data 20. This is because the 1 pixel recognized as constituting a first intermediate tonal region 36 is highly possibly a region corresponding to, for example, text 23 or a spot/stain smaller than the QR code in the image data 20.

Also, as shown in FIG. 14B, in the case of a first intermediate tonal region 36 that consists of a predetermined number of pixels in a line lying vertically or horizontally and adjacent to pixels each with a pixel value more than the upper limit of the predetermined intermediate tonal values on both sides (e.g., in the case where all those adjacent pixels are white pixels), the region recognized as a first intermediate tonal region 36 is highly possibly a region (noise) not corresponding to the region with the QR code 21 in the image data 20. This is because the region recognized as a first intermediate tonal region 36 is highly possibly a region corresponding to a ruled line 22 in the image data 20.

Since the regions having the characteristics above are included in the first intermediate tonal regions 36, regions of the image data 20 corresponding to these regions (noise) could end up in being searched and analyzed by the information code searcher/analyzer 213. The search in the regions of the image data 20 corresponding to the regions (noise) having the characteristics above would be a waste of time. Removing such regions (noise) from the first intermediate tonal regions 36 allows reduction of regions to be searched by the information code searcher/analyzer 213, which will be described later.

Thereafter, in step S23, the information code searcher/analyzer 213 searches for and analyzes the QR code 21 in the regions of the image data 20 corresponding to the first intermediate tonal regions 36 after the removal of any region to be noise by the remover, so that the search and analysis of the QR code 21 can be performed at a high speed.

In other words, the search and analysis of the QR code 21 are executed in any region of the image data 20 corresponding to only one or more first intermediate tonal regions 36, so that the search and analysis of the QR code 21 can be performed at a high speed.

The regions to be removed as noise can appropriately be set depending on the format of the document on which the QR code 21 is printed, the factor of reduction, and other conditions. Specifically, in the case of first intermediate tonal regions 36 each consisting of a line of pixels lying vertically or horizontally, the length (the number of pixels) of the line as a criterion for removal can be set as appropriate.

### <Function of Intermediate Tonal Region Expander (Step S24)>

In the generation of the reduced image data 30 by reducing the image data 20, some pixels with or around the contour of the QR code 21 of the image data 20 may be converted to the corresponding pixels of the reduced image data 30 through calculation using the pixel values of the pixels constituting the QR code 21 and the pixel values of the pixels not constituting the QR code.

A pixel value calculated as such may not fall within the predetermined intermediate tonal pixel value range.

This means that a pixel with such a pixel value is not recognized as constituting the first intermediate tonal region 36.

Also, with a high density of white pixels or a high density of black pixels in the QR code 21, if any, the pixel values of the pixels constituting a region of the reduced image data 30 corresponding to such a high-density region may be outside the predetermined intermediate tonal pixel value range.

In addition, due to the accuracy and noise in capturing the image data 20, the pixel values of some pixels constituting a region of the reduced image data corresponding to the region of the QR code 21 may be outside the predetermined intermediate tonal pixel value range.

In other words, a certain pixel in a region of the reduced image data 30 corresponding to the region with the QR code 21 in the image data 20 may not be recognized as constituting a first intermediate tonal region 36 in some cases.

The information code searcher/analyzer 213 searches for the QR code 21 in any region of the image data 20 corresponding to a first intermediate tonal region 36 of the reduced image data 30. Thus, the information code searcher/analyzer 213 would end up not searching in the region of the image data 20 corresponding to the region with the above certain pixel in the reduced image data 30 even if this region of the image data 20 actually contained the QR code 21.

This may make the information code searcher/analyzer 213 unable to analyze the QR code 21.

To prevent such a problem, the intermediate tonal region expander may expand the first intermediate tonal regions 36. Specifically, the intermediate tonal region expander may expand each first intermediate tonal region 36 by, for example, adding 1 pixel to the periphery thereof. With the first intermediate tonal regions 36 expanded as described above, the entire QR code 21 can be included in a region of the image data 20 corresponding to any of the expanded regions.

### <Function of Information Code Searcher/Analyzer (Step S25)>

Then, in step S25, the information code searcher/analyzer 213 searches for and analyzes the QR code 21 in the regions of the image data 20 corresponding to the regions including both the first intermediate tonal regions 36 before the expansion and the regions added by the expansion by the intermediate tonal region expander, which makes it easier to find and analyze the QR code 21.

The range by which a first intermediate tonal region 36 is to be expanded can appropriately be set depending on the factor of reduction and other conditions.

Specifically, although the intermediate tonal region expander expanded each first intermediate tonal region 36 by adding only 1 pixel to the periphery thereof in the case above, the first intermediate tonal region 36 may be expanded by adding 2 or more pixels to the periphery thereof.

The image processing device 210 according to Embodiment 2 may perform only one of step S23 and step S24.

### Embodiment 3

Next, an image processing device according to Embodiment 3 of the present disclosure is described.

Image data acquired from a document on which an information code is printed may appear darker or lighter depending on the type of device that acquires the image data and the conditions during the acquisition.

In reduced image data obtained by reducing such image data, the pixel values of some pixels in the region of the reduced image data corresponding to the region with the information code of the image data may not fall within the preset intermediate tonal pixel value range. In this case, the region of the reduced image data corresponding to the region with the information code of the image data would not be recognized as a first intermediate tonal region.

This makes the information code searcher/analyzer unable to find the information code when searching for the information code in the regions of the image data corresponding to the first intermediate tonal regions.

The image processing device according to Embodiment 3 of the present disclosure has a mechanism that enables the information code searcher/analyzer to easily find the information code even in such a case.

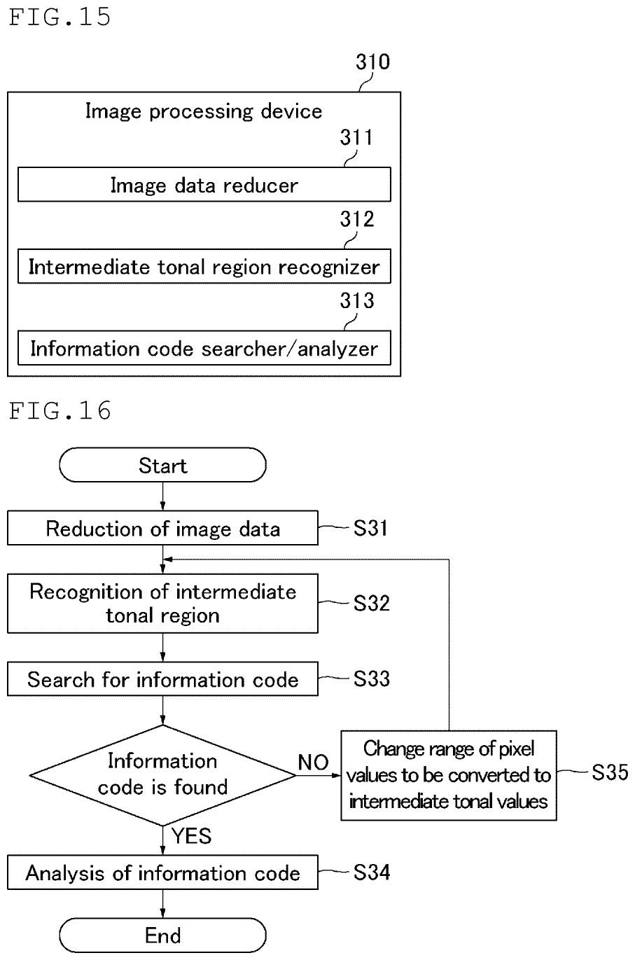

FIG. 15 is a block diagram illustrating the configuration of the image processing device according to Embodiment 3.

An image processing device 310 shown in FIG. 15 includes an image data reducer 311, an intermediate tonal region recognizer 312, and an information code searcher/analyzer 313. The image data reducer 311, the intermediate tonal region recognizer 312, and the information code searcher/analyzer 313 may be processed by an arithmetic processor including arithmetic circuitry such as a CPU.

The image processing device 310 according to Embodiment 3 differs from the image processing device according to Embodiment 1 in that in the case where the information code is not found in any region of the image data corresponding to at least one first intermediate tonal region, the intermediate tonal region recognizer 312 recognizes any region with a pixel value within a second pixel value range different from the above predetermined pixel value range (first pixel value range) as a second intermediate tonal region, and the information code searcher/analyzer 313 searches for and analyzes the information code in a region of the image data corresponding to the at least one second intermediate tonal region.

The operation of the image processing device according to Embodiment 3 is described with reference to FIG. 16.

FIG. 16 is a flowchart illustrating an example of the operation of the image processing device according to Embodiment 3.

As shown in FIG. 16, in the image processing device 310, first, the image data reducer 311 reduces image data to obtain reduced image data (step S31).

Next, the intermediate tonal region recognizer 312 recognizes, as a first intermediate tonal region, any region with a pixel value within a first pixel value range from the reduced image data (step S32).

Subsequently, the information code searcher/analyzer 313 searches for an information code in any region of the image data corresponding to at least one first intermediate tonal region (step S33).

If the information code is found in step S33, the information code searcher/analyzer 313 analyzes the information code (step S34), so that the operation of the image processing device according to Embodiment 3 ends.

If the information code is not found in step S33, the intermediate tonal region recognizer 312 sets a second pixel value range different from the first pixel value range (step S35).

Next, returning to step S32, the intermediate tonal region recognizer 312 recognizes any region with a pixel value within the second pixel value range as a second intermediate tonal region.

Then, the information code searcher/analyzer 313 searches for the information code in any region of the image data corresponding to at least one second intermediate tonal region (step S33).

Thereafter, step S35, step S32, and step S33 are repeated with the pixel value range to be recognized in step S35 being changed until the information code is found. If the information code is found in step S33, the information code searcher/analyzer 313 analyzes the information code (step S34), so that the operation of the image processing device according to Embodiment 3 ends.

The “second pixel value range” to be set in step S35 in the image processing device 310 according to Embodiment 3 may be preset.

The “second pixel value range” means a pixel value range different from the “first pixel value range” in at least one of the lower limit pixel value and the upper limit pixel value.

For example, the second pixel value range may be a range that overlaps the first pixel value range and is obtained by shifting the first pixel value range upward.

The second pixel value range may be a range that overlaps the first pixel value range and is obtained by shifting the first pixel value range downward.

The second pixel value range may be a range that does not overlap the first pixel value range and is higher than the first pixel value range. In this case, the upper limit value of the first pixel value range and the lower limit value of the second pixel value range may be consecutive pixel values or inconsecutive (separate) pixel values.

The second pixel value range may be a range that does not overlap the first pixel value range and is lower than the first pixel value range. In this case, the lower limit value of the first pixel value range and the upper limit value of the second pixel value range may be consecutive pixel values or inconsecutive (separate) pixel values.

The width from the minimum value to the maximum value of the second pixel value range may be the same as or different from the width from the minimum value to the maximum value of the first pixel value range.

Specifically, when the image data is a grayscale image with 256 values and the first pixel value range is set to values from 50 to 200, the second pixel value range may be set to values from 75 to 225 or values from 25 to 175. Furthermore, when the first pixel value range is set to values from 100 to 150, the second pixel value range may be set to values from 151 to 200 or values from 50 to 99.

### Embodiment 4

Next, an image processing device according to Embodiment 4 of the present disclosure is described.

Image data acquired from a document on which an information code is printed may appear darker or lighter depending on the type of device that acquires the image data.

If the type of device that acquires the image data is known in advance, the range of pixel values of intermediate tonal values can be determined according to the type of device that acquires the image data, which enables optimization of the information code search and analysis. An image processing device 410 according to Embodiment 4 has such a mechanism.

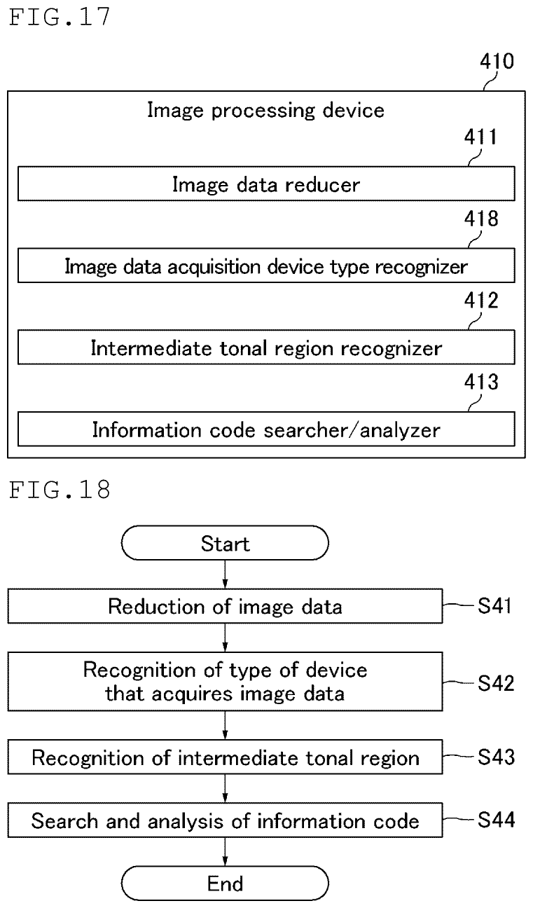

FIG. 17 is a block diagram illustrating the configuration of an image processing device according to Embodiment 4.

The image processing device 410 shown in FIG. 17 includes an image data reducer 411, an image data acquisition device type recognizer 418, an intermediate tonal region recognizer 412, and an information code searcher/analyzer 413. The image data reducer 411, the image data acquisition device type recognizer 418, the intermediate tonal region recognizer 412, and the information code searcher/analyzer 413 may be processed by an arithmetic processor including arithmetic circuitry such as a CPU.

The operation of the image processing device according to Embodiment 4 is described with reference to FIG. 18.

FIG. 18 is a flowchart illustrating an example of the operation of the image processing device according to Embodiment 4.

As shown in FIG. 18, in the image processing device 410, first, the image data reducer 411 reduces image data to obtain reduced image data (step S41).

Next, the image data acquisition device type recognizer 418 recognizes the type of device that acquires the image data (step S42). For example, the image data acquisition device type recognizer 418 acquires information indicating the type of device that acquires the image data to recognize the type.

While a device that acquires an image data means a digital camera, an image scanner, or the like device, the type of device that acquires image data means the model number, the model name, and the like information on the device.

Next, the intermediate tonal region recognizer 412 recognizes any first intermediate tonal region from the reduced image data using the range of pixel values to be converted to intermediate tonal values, the range preset to correspond to the type of device that acquires image data (step S43).

Subsequently, the information code searcher/analyzer 413 searches for an information code in any region of the image data corresponding to at least one first intermediate tonal region (step S44), so that the operation of the image processing device 410 ends.

In the image processing device 410, types of devices that acquire image data and ranges of pixel values to be converted to intermediate tonal values may be linked and stored in advance, and when the intermediate tonal region recognizer 412 recognizes a first intermediate tonal region, the intermediate tonal region recognizer 412 may refer to the range of pixel values to be converted to intermediate tonal values linked to the type of device that acquires image data.

In the processing device 410, step S41 may be performed after step S42.

The image processing device 410 may generate an image for visually checking an information code and an image for reading the information code.

The tones may be different between the image for visually checking an information code and the image for reading the information code.

This is because the ideal tone of an image may differ between the image for visually checking an information code and the image for reading the information code.

In addition, the image processing device 410 may generate an image for visually checking text and an image for OCR text processing.

The tones may be different between the image for visually checking text and the image for OCR text processing.

This is because the ideal tone of an image may differ between the image for visually checking text and the image for OCR text processing.

### Embodiment 5

Embodiment 1 to Embodiment 4 describe the cases where the image processing device consists of one device. Yet, the functions of the image processing device may be achieved by a distributed processing system in which these functions are distributed to multiple devices as appropriate.

For example, the image data reducer, the intermediate tonal region recognizer, the information code searcher, and the information code analyzer may be incorporated in different devices, and communication may be established between the devices to allow continuous processing by the devices.

In addition, the information code searcher and the information code analyzer may be built on the cloud to search for and analyze an information code.

For example, in an image processing system including a first processing device including a first arithmetic processor and a second processing device including a second arithmetic processor, the first arithmetic processor in the first processing device may process the image data reducer and the intermediate tonal region recognizer, and the second arithmetic processor in the second processing device may process the information code searcher and the information code analyzer.

Such an image processing system is also the image processing system according to the present disclosure.

### (Information Code Search Method)

An information code search method in the information code search system, including reducing image data to obtain reduced image data, recognizing any first intermediate tonal region with a predetermined intermediate tonal pixel value from the reduced image data, searching for an information code in any region of the image data corresponding to at least one first intermediate tonal region, and analyzing the information code, is also the information code search method according to the present disclosure.

### Embodiment 6

Next, a slip handling device incorporating the image processing device according to the present disclosure is described.

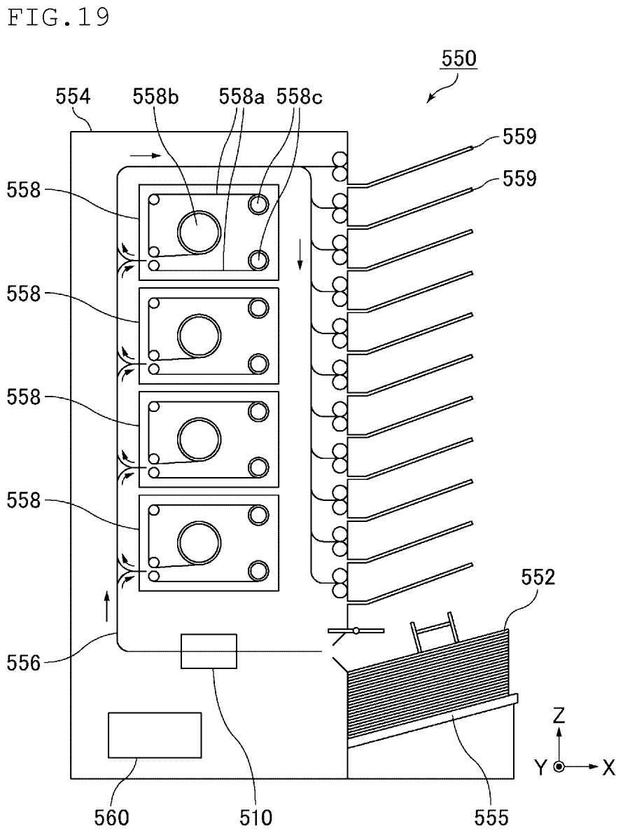

FIG. 19 is a cross-sectional view showing an example of a slip handling device incorporating the image processing device according to the present disclosure.

Slips 552 to be handled by a slip handling device 550 in FIG. 19 include slips with an information code printed thereon, such as utility bill payment slips, national tax payment slips, and social insurance premium payment slips.

The slip handling device 550 includes a device body 554, a slip feeding unit 555 which separates a stack of slips 552 to feed out the slips 552 one by one (or one book at a time) into the device body 554, a transport path 556 which transports the slips 552 fed out by the slip feeding unit 555 into the device body 554, an image processing device 510 which searches for and analyzes an information code printed on the slips 552 transported along the transport path 556, temporary holding units 558 which, according to the analysis results by the image processing device 510, temporary hold the slips 552 received from the transport path 556 and send the temporary held slips 552 to the transport path 556, sorting units 559 which sort the slips 552 transported along the transport path 556 by type, and a control unit 560 which controls the slip handling device 550.

The image processing device 510 in the slip handling device 550 may be the image processing device described in any of Embodiments 1 to 4 above including an image capturing unit which captures the slips 552 as image data.

The temporary holding units 558 each include a pair of strips of tape 558a, a winding roller 558b which overlaps first ends of the strips of tape 558a to wind up them together, and a pair of winding reels 558c which respectively wind up the second ends of the strips of tape 558a. To hold the slips 552, each temporary holding unit winds up the strips of tape 558a around the winding roller 558b while unwinding the strips of tape 558a from the respective winding reels 558c, so that the slips 552 sent one by one from the transport path 556 are sandwiched between the strips of tape 558a and wound together with the strips of tape 558a around the winding roller 558b for storage. To feed out the slips 552, the temporary holding unit winds up the strips of tape 558a around the respective winding reels 558c while unwinding the strips of tape 558a from the winding roller 558b, so that the slips 552 are sent one by one from between the strips of tape 558a to the transport path 556.

In the slip handling device 550, the slips 552 loaded in a stack are fed out one by one to the transport path 556 by the slip feeding unit 555, and the information code printed on the slips 552 transported along the transport path 556 is analyzed by the image processing device 510 to determine the type of the slips 552. The slips 552 whose type has been determined may be handled depending on the settings. Some of the slips 552 may be transported to the sorting units 559, all of the slips 552 may be temporarily held in the temporary holding units 558, or only some of the slips 552 that failed to be analyzed may be temporarily held in the temporary holding units 558. When the slips 552 are temporarily held in the temporary holding units 558, the slips 552 are fed out one by one from the temporary holding units 558 and transported to the sorting units 559. In the sorting units 559, the slips 552 transported along the transport path 556 are sorted by type.

Some of the slips 552 that failed to be analyzed include slips that have an information code but failed to be analyzed normally, and slips that did not have an information code.

These slips may be sorted as different types of slips in the sorting units 559.

The slip handling device 550 may also have a dedicated mode for handling slips that have an information code but failed to be analyzed normally.

In this dedicated mode, the slip transport speed may be slowed down or the program for analyzing the information code may be changed to increase the likelihood of successfully analyzing slips that have an information code but failed to be analyzed normally.

In addition, the dedicated mode may be incorporated into the configuration of the slip handling device 550, or may be provided in a separate device.

A slip that has an information code but failed to be analyzed normally can be identified as follows.

The information code searcher/analyzer, if including an information code detection algorithm and an information code analysis algorithm separately, may be able to recognize a region likely with an information code in accordance with the information code detection algorithm but may fail to analyze the information code in accordance with the information code analysis algorithm.

In this case, the slip in question can be determined as one that has an information code but failed to be analyzed normally.

Such a case where a region likely with an information code can be recognized but the information code fails to be analyzed corresponds, for example, to a case where the information code is dirty or smudged, hiding part of the information code and making it impossible to analyze the information code.

When slips are handled by the slip handling device 550, a cover sheet may be set on a bundle of slips, and the cover sheet may indicate the number of slips in the bundle.

In such cases, the slip handling device may acquire information on the number of slips indicated by the cover sheet using OCR processing or the like, and may handle the slips by assuming that “those transported after the processing are slips” and “one transported after handling the given number of slips is the cover sheet”.

As described above, the present disclosure provides a technology that is useful for allowing a high-speed search and analysis of an information code in image data acquired from a document with an information code whose position and size are not known in advance.

What is claimed is:

1. An image processing device comprising arithmetic circuitry,
the arithmetic circuitry configured to:
reduce image data to obtain reduced image data;
recognize at least one first intermediate tonal region with a predetermined intermediate tonal pixel value from the reduced image data;
search for an information code in a region of the image data corresponding to the at least one first intermediate tonal region; and
analyze the information code.

2. The image processing device according to claim 1,
wherein the arithmetic circuitry is configured to calculate an average of pixel values for each of a plurality of regions of the image data, and generates image data with the calculated averages taken as pixel values as the reduced image data.

3. The image processing device according to claim 1,
wherein the arithmetic circuitry is configured to recognize, as the at least one first intermediate tonal region, at least one region with a pixel value falling within a first pixel value range in the reduced image data.

4. The image processing device according to claim 1,
wherein the arithmetic circuitry is configured to convert the reduced image data to three pixel values of black, white, and gray, and recognize at least one region converted to a gray pixel value as the at least one first intermediate tonal region.

5. The image processing device according to claim 3,
wherein in a case where the information code is not found in any region of the image data corresponding to the at least one first intermediate tonal region,
the arithmetic circuitry is configured to:
recognize at least one region with a pixel value falling within a second pixel value range different from the first pixel value range as at least one second intermediate tonal region; and
search for the information code in a region of the image data corresponding to the at least one second intermediate tonal region.

6. The image processing device according to claim 1,
wherein the arithmetic circuitry is configured to:
expand the at least one first intermediate tonal region; and
search for the information code in a region of the image data corresponding to the at least one region expanded.

7. An information code search method in an information code search system, the information code search method comprising:
reducing image data to obtain reduced image data;
recognizing at least one first intermediate tonal region with a predetermined intermediate tonal pixel value from the reduced image data;
searching for an information code in a region of the image data corresponding to the at least one first intermediate tonal region; and
analyzing the information code.

8. The information code search method according to claim 7,
wherein the reducing includes calculating an average of pixel values for each of a plurality of regions of the image data, and generating image data with the calculated averages taken as pixel values as the reduced image data.

9. The information code search method according to claim 7,
wherein the recognizing includes recognizing, as the at least one first intermediate tonal region, at least one region with a pixel value falling within a first pixel value range in the reduced image data.

10. The information code search method according to claim 7,
wherein the recognizing includes converting the reduced image data to three pixel values of black, white, and gray, and recognizing at least one region converted to a gray pixel value as the at least one first intermediate tonal region.

11. The information code search method according to claim 9, further comprising,
in a case where the information code is not found in any region of the image data corresponding to the at least one first intermediate tonal region in the searching,
recognizing at least one region with a pixel value falling within a second pixel value range different from the first pixel value range as at least one second intermediate tonal region, and
searching for the information code in a region of the image data corresponding to the at least one second intermediate tonal region.

12. The information code search method according to claim 7, further comprising expanding the at least one first intermediate tonal region,
wherein the searching includes searching for the information code in a region of the image data corresponding to the at least one region expanded in the expanding.

13. A storage medium that stores an information code search program,
the information code search program causing an image processing device to:
reduce image data to obtain reduced image data;
recognize at least one first intermediate tonal region with a predetermined intermediate tonal pixel value from the reduced image data;
search for an information code in a region of the image data corresponding to the at least one first intermediate tonal region; and
analyze the information code.

14. The storage medium according to claim 13,
wherein the reducing in the information code search program includes calculating an average of pixel values for each of a plurality of regions of the image data, and generating image data with the calculated averages taken as pixel values as the reduced image data.

15. The storage medium according to claim 13,
wherein the recognizing in the information code search program includes recognizing, as the at least one first intermediate tonal region, at least one region with a pixel value falling within a first pixel value range in the reduced image data.

16. The storage medium according to claim 13,
wherein the recognizing in the information code search program includes converting the reduced image data to three pixel values of black, white, and gray, and recognizing at least one region converted to a gray pixel value as the at least one first intermediate tonal region.

17. The storage medium according to claim 15,
wherein in a case where the information code is not found in any region of the image data corresponding to the at least one first intermediate tonal region in the searching in the information code search program,
the information code search program causes the image processing device to:
recognize at least one region with a pixel value falling within a second pixel value range different from the first pixel value range as at least one second intermediate tonal region, and
search for the information code in a region of the image data corresponding to the at least one second intermediate tonal region.

18. The storage medium according to claim 13,
wherein the information code search program causes the image processing device to further expand the at least one first intermediate tonal region, and
the searching in the information code search program includes searching for the information code in a region of the image data corresponding to the at least one region expanded in the expanding.
